(19) United States
(12) Patent Application Publication
(10) Pub. No.: US 2002/0143674 A1
(43) Pub. Date: Oct. 3, 2002

(54) Invoice distribution method and apparatus

(76) Inventor: Orhan E. Beckman, Camas, WA (US)

Correspondence Address: HEWLETT-PACKARD COMPANY, Intellectual Property Administration, P.O. Box 272400, Fort Collins, CO, 80527-2400, US

(21) Appl. No.: 09/821,355

(22) Filed: Mar. 29, 2001

(51) Int. Cl. G06F 17/60

(52) U.S. Cl. 705/34

(57) ABSTRACT

A centralized method of collecting and consolidating bills and invoices from unrelated vendors of goods and services takes advantage of the data transfer capabilities of the Internet. Unrelated or disparate vendors of goods and services transfer billing information to a centralized bill consolidation server, which extracts billing information and creates a standardized or predetermined-format billing statement that can be electronically delivered to a customer of the vendors via e-mail or U.S. Postal Service. In an alternate embodiment automatic bill payment can be enabled through the Internet by prior agreement with a financial institution.

### BACKGROUND OF THE INVENTION

In this age of wireless communications and data networks that stretch across the globe, there may be no end to the uses to which this communications technology may be put. In an increasingly complex society, wherein consumers and businesses alike, transact more and more business in shorter time periods, a common problem that many consumers and businesses experience, is keeping accounts (of both assets and liabilities) current, i.e. up to date. Many consumers receive daily deliveries of unpaid bills and invoices from purveyors of goods and services, which eventually need to be paid or otherwise disposed of. Similarly, almost all businesses prefer to promptly bill their customers quickly and on-time in the hope of maintaining a positive cash flow.

At present, many consumers and businesses pay their bills by manually writing out checks, drafts or send money orders to vendors of goods and services. These bills are typically received via the U.S. postal service, which most vendors of goods and services use to deliver bills to their customers.

A method and system for electronically consolidating bills from several vendors and for delivering each of the bills to the appropriate recipient would yield a business cost reduction and might likely yield an improvement in cash flow by delivering bills more promptly than is possible by mail and with fewer lost or mis-delivered parcels.

### SUMMARY OF THE INVENTION

There is provided a method and apparatus that helps collect and consolidate bills and invoices for sales of goods and services at a single “location” by a single service provider. In one embodiment, the method includes the steps of electronically collecting billing information from vendors of goods and services at a billing consolidation server (i.e. one or more computers) using a data network, which electronically links the consolidation server and the servers (i.e. the computers) of the vendors together. The billing information passed to the consolidation server includes data files that contain billing information that is to be sent to customers. Billing information from the vendors is parsed by the consolidation server so as to extract pertinent data. The parsed data is then is formatted for delivery to a printer or other output device at the delivery point, i.e. the customer of the various vendors. At least one alternate embodiment includes debiting a customers account at a financial institution to automatically pay for services and goods that have been billed to the customer.

### BRIEF DESCRIPTION OF THE DRAWINGS

FIG. 1 shows a simplified block diagram of a system by which billing information can be automatically collected, formatted into a standard format and delivered to a customer via a data network such as the Internet.

FIG. 2 shows a simplified flow diagram of the steps of the method by which bills and invoices can be collected from several vendors, parsed into a standard format and sent to an intended recipient.

### DETAILED DESCRIPTION OF THE PREFERRED EMBODIMENT

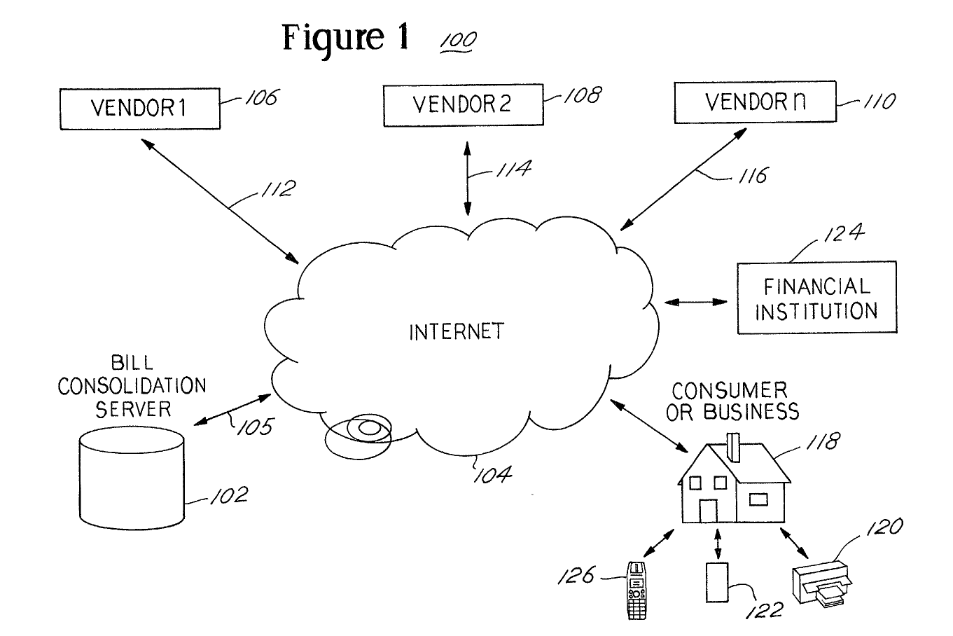

FIG. 1 shows a simplified block diagram of a system for automatically collecting financial statements, such as bills and invoices for goods and services sold by vendors, and, consolidating such statements into a standardized format and electronically distributing them to the appropriate recipients for payment. The system 100 of FIG. 1 includes at least a bill consolidation server 102 of a bill consolidation service provider (not shown) that is coupled to a data network, preferably the Internet 104 by means of an appropriate data link 106. Servers 106, 108 and 110 of vendors of goods and services are also coupled to the data network 104 as is at least one consumer that is a customer of at least one of the vendors who provide billing data to the bill consolidation service provider.

The bill consolidation server 102 can be any appropriately-capable computer such as a stand alone personal computer but might also include a distributed network of processors or work stations that is capable of receiving billing data from other computers either via a data network such as the Internet, or via other methods, such as removable storage media, FTP file transfers and the like. For claim construction purposes, stand alone PCs, work stations and networks of computers are considered to be equivalent forms of processors that are capable of receiving billing data. Such processors are all capable of receiving data, and by way of appropriate application software, formatting data for printing or other output on a monitor, PDA, cell phone, pager, or other display device. In the preferred embodiment, the consolidation server has the capability of accessing the Internet 104, or some other data network (e.g. Ethernet, ATM, frame relay), by which it can at least receive data from the servers (computers) of at least some vendors who subscribe to an electronic bill consolidation service. Each of the servers shown in FIG. 1 are coupled to the data network over which they communicate with each other using appropriate data links 105, 112, 114, 116.

In the preferred embodiment, the data network 104 is comprised of the World Wide Web of the Internet 104, which is a well-known network of computers that exchange data between each other according to well-defined Internet protocol (IP) communications standards. As set forth above, alternate embodiments of the invention would include other types of data networks that are capable of exchanging packets of data between computers by means of addressing those data packets in such a way that they are delivered to an intended recipient.

Web servers 106, 108, and 110 of vendors of various goods and services are coupled to the Internet 104 through respective data links 112, 114, and 116 and either provide to the consolidation server 102, access to business records, or retrieve such records upon request and send them to the consolidation server 102 where such records are processed. Stated alternatively, the bill consolidation server 102 can ask for and receive, billing data or invoice data from each of the respective vendors web servers 106, 108, and 110 so as to obtain by way of a data exchange enabled by the Internet 104, billing data for goods and/or services that have been rendered by the respective vendors to a consumer 118. Billing data or invoice data from the servers would include, but not be limited to, a description of goods and services sold, leased, rented, rendered or otherwise provided to, at the behest of one or more putative customers of the vendor. The name, address, phone number and e-mail address of the customer to which the statement or bill should be sent. A record of past payments or current account status, including accrued interest could also be sent to the consolidation server 102, which can include all or selected portions of the billing data it receives. Agreements between the vendors, the customers and the consolidated bill collection service provider would likely be required to enable the transfer of such information.

Those skilled in the art will recognize that while the bill consolidation server 102 might query the respective vendor servers 106, 108, 110, alternate embodiments would certainly include servers 106, 108, and 110, that spontaneously, or at a preprogrammed intervals, deliver data to the bill consolidation server 102, the billing data that the vendors prefer or need to deliver to the customers for payment. In such an alternate embodiment, the respective vendors servers, would forward to the bill consolidation server 102 the bills and/or statement or invoices that the vendors wish to send to the consumer 118.

Once the bill consolidation server 102 has obtained or has otherwise received billing data, the bill consolidation server parses the data files (which the vendor servers send to the consolidation server) of information from the respective vendor servers to extract therefrom, pertinent billing information for the respective vendors. The parsed data is formatted by the bill consolidation server into a standardized or uniform billing format so as to present or send to an output device, such as a printer or screen, a statement or invoice that is easily readable by the consumer of its obligations to the respective vendor(s). A consumer or other business entity 118 that subscribes to the centralized bill consolidation service can thereby have a single, unified bill in the form of a data file and which includes outstanding liabilities to a plethora of creditors, sent to it via e-mail or, printed by the server 102 and delivered by an appropriate delivery service. An electronically-delivered statement can be printed locally 120 for review, archival or other purposes. In at least one alternate embodiment, payment of liabilities can also be accomplished from the consumer's PC.

Those skilled in the art will recognize that the bill consolidation server 102 can prepare the data it collects from the various vendors into any output format that either the vendors, the bill consolidation service provider (not shown) or the consumer might prefer. By way of example, a consumer may wish to have his bills from utility companies presented first. Statements from retail merchants might be specified by the consumer to appear after, or below, utility bills. Mortgage statements or other secured loans that might be due and owing by the consumer might be arranged below the bills of retailers. The particular designs or arrangements of bills delivered to customers of the bill consolidation service would be a design choice of either the consumer, the bill consolidation service provider or the respective vendors. The bill consolidation server, is presumably programmed to format the billing data according to the wishes of either the consumer or the vendors or the service provider and prepares the consolidated billing information for appropriate printing on an output device such as a printer 120.

In addition to sending billing statements or invoices, the system of FIG. 1 can also be used to send statements from financial services companies, banks, brokerage houses and the like, all of which are considered to be asset reports or account balances. Instead of sending bills, the system can send to consumers their account balances and the like. For purposes of claim construction, sending billing statement and sending financial statements and account balances are, for simplicity, considered equivalent under the rubric of a data file containing “billing information” (an entity accruing interest that is payable to a consumer or business incurs a liability evidenced as its “bill” memorializing its liability) or simply “financial information.” In instances where the system of FIG. 1 is delivering account balances, for purposes of claim construction, “vendors” and the servers thereof shown in FIG. 1 would then include, but not be limited to, financial institutions such as banks, brokerage houses or other dividend, interest or sources of capital appreciation.

Alternate output devices to which the standardized-format statement could be sent would of course include a personal computer (not shown) but also directly to a personal digital assistant or PDA 122, which a consumer 118 might hot link by means of an infrared data link between the consumers PC and the PDA 122. Still other embodiments include output devices such as cellular and/or personal communications service (PCS) telephones with some modicum of data display capability, pagers or other wireless communications devices 126 to which data can be sent and either displayed on, or printed from.

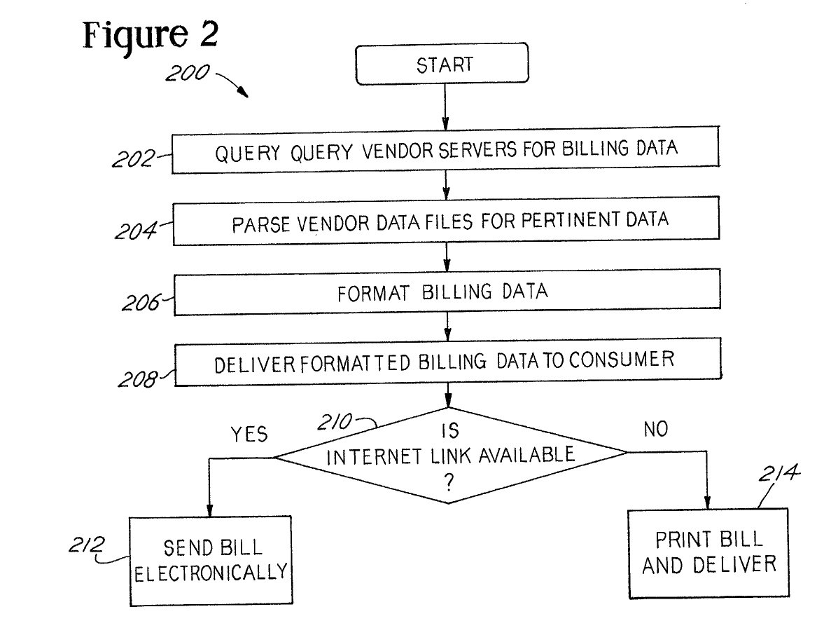

FIG. 2 shows a simplified flow diagram of an exemplary method 200 by which bills and/or statements or invoices for goods and services (as well as financial statements or account balances) can be centrally collected, consolidated and delivered to a customer (consumer or business) from the centralized collection and consolidation service provider.

In step 202 the bill consolidation server shown in FIG. 1 in the preferred embodiment queries the servers of vendors of goods and services for billing data. Such a query will typically come in the form of a data packet addressed to the respective servers 106, 108, or 110 requesting from the server, billing information that the servers 106, 108, and 110 have been provided with, or programmed to generate for collection. As mentioned above, alternate embodiments would include a push down billing statement generation whereby the vendor servers would autonomously deliver to the bill consolidation server 102 data or files of billing information that need to be sent to a customer for payment.

Inasmuch as various unrelated vendors will, in all likelihood, generate disparate data files of billing information, pertinent information that is to be reformatted into a standardized invoice statement or bill must be parsed from the respective vendor billing files to extract billing data. In step 204, a bill consolidation server parses vendor billing data from the data files that the vendors send to the bill consolidation server 102.

Inasmuch as the vendors must willingly provide access to sensitive customer information and sensitive customer data, workability of the centralized bill consolidation collection, formatting and delivery service disclosed herein presumes the separate agreement of the vendors with a bill consolidation service provider. Such an agreement would require that the vendors provide some sort of map or template of where the billing information in the files on the respective servers 106, 108, and 110 might be found if such information is not delivered readily to the server 102. Additionally, the vendors must provide data to the bill consolidation service provider of where to deliver billing statements or invoices, either by e-mail address or U.S. Postal Service address if the bill consolidation server is not requested to deliver the billing statements electronically.

In step 206, the parsed vendor billing data is formatted by the bill consolidation server 102 into a standardized billing format. The formats into which a standardized bill might be cast or created is a design choice. Formats might be selected from a library of different styles that might be selected by either the consumer 118 or individual vendors as the bill consolidation service provider prefers.

In step 208, the bill consolidation server must deliver the reformatted billing data to the consumer for payment. In step 210, the bill consolidation server 102 makes a determination of whether or not the consumer or business to which the billing data is to be delivered 118 is provided with Internet data service thereby enabling delivery of the billing information by e-mail or other appropriate package. In step 212, if the consumer has Internet service, the billing information can be delivered by an e-mail message or other data package that is routed to the consumer through its Internet service provider. In an alternate embodiment, the bill consolidation server 102 can manually print out bills for delivery by the U.S. Postal Service as set forth in step 214. In such an embodiment, the bill consolidation server 102 would at least be a centralized billing and collection point from which a customers bills from a variety of service providers and vendors can be formatted into a standard format for easy understanding and payment.

Those skilled in the art will recognize the advantages provided by the invention disclosed herein. Several potentially unrelated service providers or vendors of goods can, by agreement with a bill consolidation service provider, forward to the service providers' computer server 102, bills and other invoices that presumably will be paid by the customer 118. By quickly transferring billing information electronically via a data network, such as the Internet, invoices for services might be more rapidly generated and delivered to a consumer for payment at least reducing the expense associated with in-house billing operations, and possibly avoiding at least the expense of postage that is presently incurred using the prior art methods of bill delivery.

In an alternate embodiment, the consumer 118 might enable the bill consolidation service provider (not shown) to access funds on deposit at a financial institution 124 via an electronic funds transfer occurring over the Internet 104. By prior arrangement, the consumer 118 might authorize a lending institution or bank or other financial entity to make funds available to the bill consolidation service provider such that the server can effectuate a funds transfer from the financial institution 124 to the vendors directly or alternatively through the bill consolidation server possibly providing another mechanism by which the bill consolidation service provider might generate revenue for its own service. Payment for such an automatic service might be made by prearrangement between the vendors and the bill consolidation server or between the consumer or between all three concerned parties.

What is claimed is:

1. A method of collecting and consolidating invoices comprised of the steps of:
receiving at a first processor from a vendor via a data network, billing information to be sent to an intended recipient;
formatting said billing information into a bill of a predetermined format for a recipient of said billing information;
delivering said bill of a predetermined format to a predetermined recipient.

2. The method of claim 1 wherein said step of receiving said billing information includes the step of querying servers coupled to said data network for said at least one data file containing said billing information.

3. The method of claim 1 further including the step of: parsing said billing information to identify therein, billing data pertinent to said vendor.

4. The method of claim 1 wherein said step of formatting said billing information includes the step of formatting said billing information into at least one format of a plurality of possible predetermined formats for display on an output device.

5. The method of claim 1 wherein said step of delivering said bill to a predetermined recipient includes the step of delivering a data file via said network to a computer of said predetermined recipient that is coupled to said data network.

6. The method of claim 1 wherein said step of delivering said bill to a predetermined recipient includes the step of printing a formatted bill and delivering said printed bill to said predetermined recipient via a delivery service.

7. The method of claim 1 wherein said billing information includes financial information related to assets of said predetermined recipient.

8. The method of claim 1 wherein said vendor includes both vendors of goods and vendors of services and wherein said at least one data file contains data of debts owed to said vendors of goods and vendors of services.

9. A system for collecting and distributing standardized bills comprised of:
at least one processor, said at least one processor capable of receiving billing information;
said at least one processor including a means for receiving billing information and formatting said billing information into at least one predetermined format for output on a display device;
an interface, coupling said at least one processor to a data network over which billing information is sent and received.

10. The system of claim 9 wherein said at least one processor is a server coupled to a data network.

11. The system of claim 9 wherein said interface includes a data link to said data network.

12. The system of claim 9 wherein said data network includes the Internet.

13. The system of claim 9 further including a printer, operatively coupled to said at least one processor, said printer printing at least some of the billing information received by said at least one processor.

14. The system of claim 9 further including a personal digital assistant, (PDA) operatively coupled to said at least one processor via said data network, said PDA receiving said at least some of the billing information received by said at least one processor.

15. The system of claim 9 further including a wireless communication device operatively coupled to said at least one processor via said data network, said PDA receiving said at least some of the billing information received by said at least one processor.

16. The system of claim 9 further including a computer, operatively coupled to said at least one processor via said data network.

17. The system of claim 9 further including at least one vendor server, operatively coupled to said at least one processor via said data network.
